(19) United States
(12) Patent Application Publication
(10) Pub. No.: US 2022/0395053 A1
(43) Pub. Date: Dec. 15, 2022

(54) BREATHABLE SOLE, MOLD FOR PROCESSING BREATHABLE SOLE, AND MANUFACTURING METHOD OF BREATHABLE SOLE

(71) Applicants: Qiming Zhou, Wenzhou City (CN); Enhong Zhou, Wenzhou City (CN); Qiang Wu, Wenzhou City (CN)

(72) Inventors: Qiming Zhou, Wenzhou City (CN); Enhong Zhou, Wenzhou City (CN); Qiang Wu, Wenzhou City (CN)

(73) Assignee: Zhejiang Komanqi Biotechnology Co., Ltd.

(21) Appl. No.: 17/344,986

(22) Filed: Jun. 11, 2021

(51) Int. Cl. A43B 13/12

(52) U.S. Cl. CPC A43B 13/12

(57) ABSTRACT

Disclosed in the present invention is a breathable sole, the forming mold for producing the breathable sole, as well as a breathable sole production method, comprising a shoe breather is configured inside the outsole of the sole, the shoe breather and the outsole is integrally formed, the shoe breather includes breather upper portion, waterproof breathable film, steel wire mesh and breather lower portion, the waterproof breathable film and steel wire mesh are fixed between the lower end of the breather upper portion and the upper end of the breather lower portion, the waterproof breathable film is located on the upper end of the steel wire mesh, the waterproof breathable film and the steel wire mesh are combined together through high-temperature adhesion.

### BACKGROUND OF INVENTION

### 1. Field of the Invention

The present invention relates generally to the technical field of shoes, and more particularly to a breathable sole, the forming mold for the breathable sole, and a breathable sole manufacturing method.

### 2. Description of Related Art

Among the prior art, China Invention Patent CN201721751999.9 discloses integral waterproof and breathable shoes and the mold for producing the sole of integral waterproof and breathable shoes. In this kind of waterproof and breathable shoes, the sole is provided with a breather to realize the waterproof and breathable effects. However, the production according to the above patent is very complicated. The breather should be firstly produced, and then the breather and the sole should be fixed together to form a whole. Such separated operations will make the production of waterproof breathable soles very complicated and inefficient, and the production cost is considerably increased. Therefore, it is necessary to design breathable soles with integral formation of the shoe breather and the sole, as well as the mold for producing such soles.

### SUMMARY OF THE INVENTION

In view of the shortcomings of the prior art, the purpose of the present invention is to provide a breathable sole formed by integral casting of a shoe respirator and a sole, a forming mold of the breathable sole, and a manufacturing method of the breathable sole.

In order to achieve the above objectives, the present invention provides the following technical solutions:

A breathable sole, comprising: a sole and an upper, the sole having an outsole and an insole,

A manufacturing method for the breathable sole provided by the present invention, comprising the following steps:

selecting upper mold and lower mold, and placing a waterproof breathable film and a steel wire mesh between the upper mold and the lower mold;

closing the upper mold and lower mold, pressing the upper mold into the shoe shape chamber of the lower mold;

pouring the rubber melt through the corresponding injection channels of the upper mold and the lower mold respectively;

opening the mold after it cools down, the breather upper portion, the breather lower portion and the outsole are formed integrally, the waterproof breathable film and the steel wire mesh are fixed between the breather upper portion and the breather lower portion through adhesion under the high temperature, and through configuration of the ventilating hole core-pulling columns, after injection is completed, ventilating holes will be formed between the breather upper portion and the breather lower portion;

pouring the insole with PU or EVA material, the top of the insole being at the same level as the top of the shoe breather, and a complete breathable sole structure is formed after cooling.

The benefits of the invention are as follows:

Through configuration of the placement trough, the shoe shape chamber and the ventilating hole core-pulling column, the shoe breather can be formed integrally when forming the outsole through plastic injection, and the step to fix the shoe breather on the outsole can be avoided, thus, the production efficiency is enhanced. Moreover, with configuration of the ventilating hole and the waterproof breathable film in the shoe breather, it can realize waterproof and breathable effects. Additionally, the steel wire mesh combined below the waterproof breathable film through high-temperature adhesion can offer better support.

### BRIEF DESCRIPTION OF THE DRAWINGS

FIG. 1 is a schematic view of the 3D structure of the invention;

FIG. 2 is a plan view of the breather according to the invention;

FIG. 3 is a sectional view of the A-A structure in FIG. 2;

FIG. 4 is a plan view of the upper mold according to the invention;

FIG. 5 is a plan view of the lo mold according to the invention;

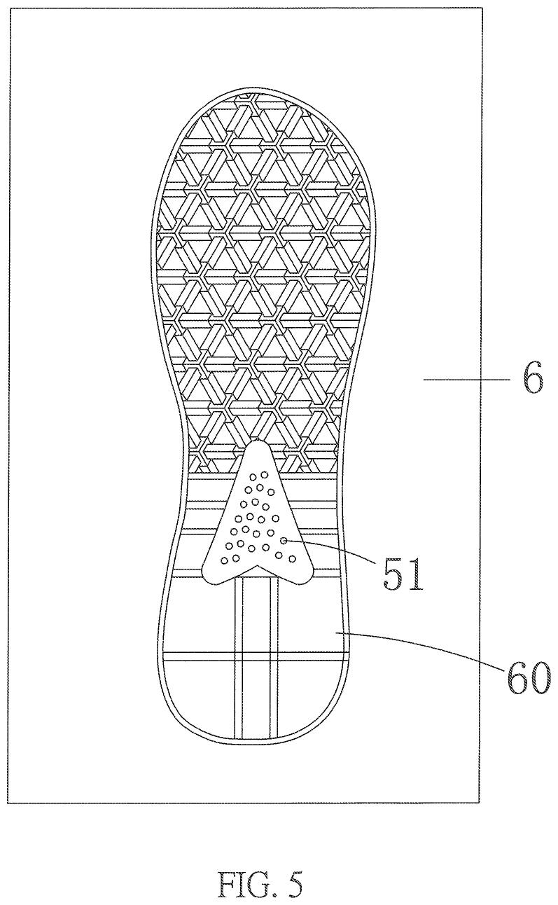

FIG. 6 is a usage state view of the upper mold and lower mold;

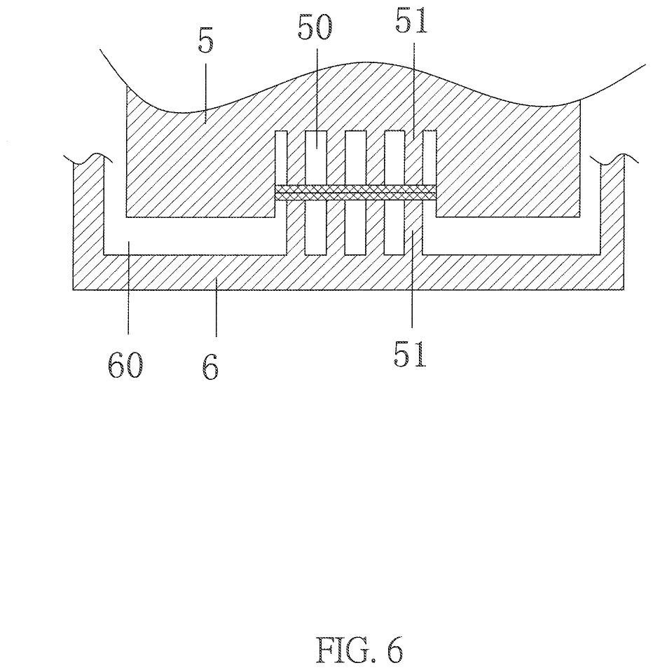

FIG. 7 is a sectional vie of the sole according to Embodiment 1;

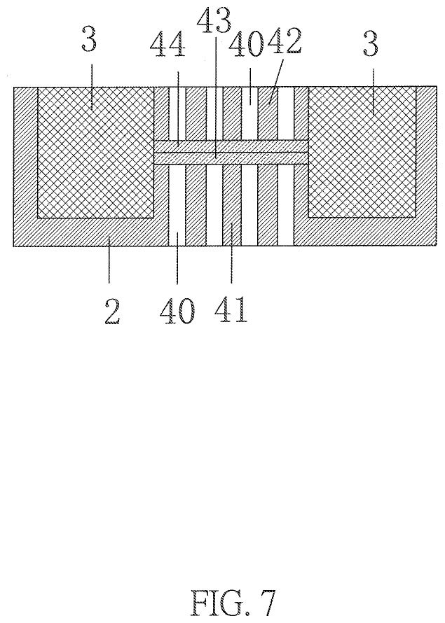

FIG. 8 is a sectional view of the sole according to Embodiment 2;

FIG. 9 is a sectional view of the sole according to Embodiment 3.

### DETAILED DESCRIPTION OF THE INVENTION

Below are further detailed descriptions of the invention with respect to the embodiments and with reference to the accompanying figures. It is to be noted, however, that the terms “front”, “back”, “left”, “right”, “upper”, and “lower” refer to the directions shown in the accompanying figures, and the terms “bottom surface”, “top surface”, “inner” and “outer” respectively refer to the direction toward to away from the geometric center of a specific part.

### Embodiment 1

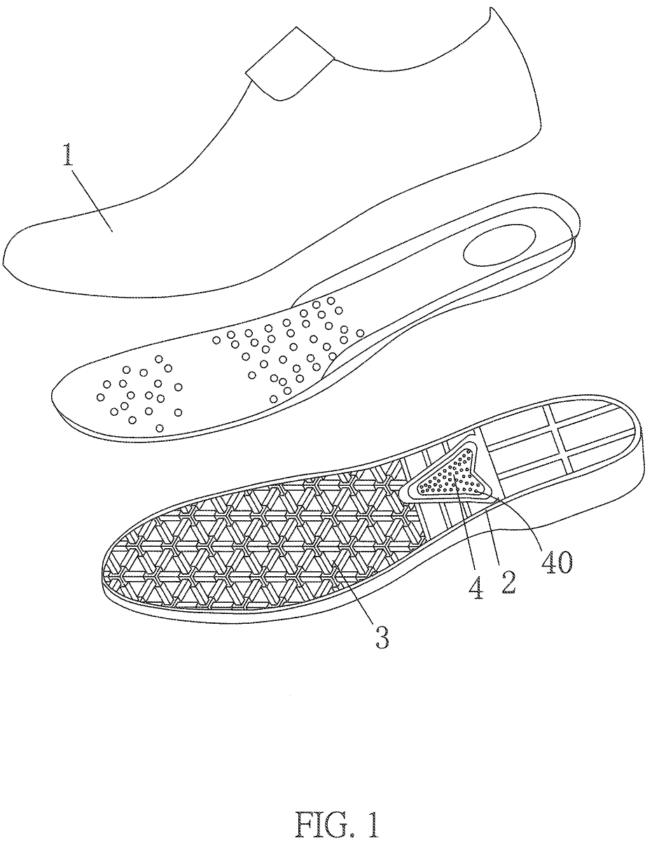

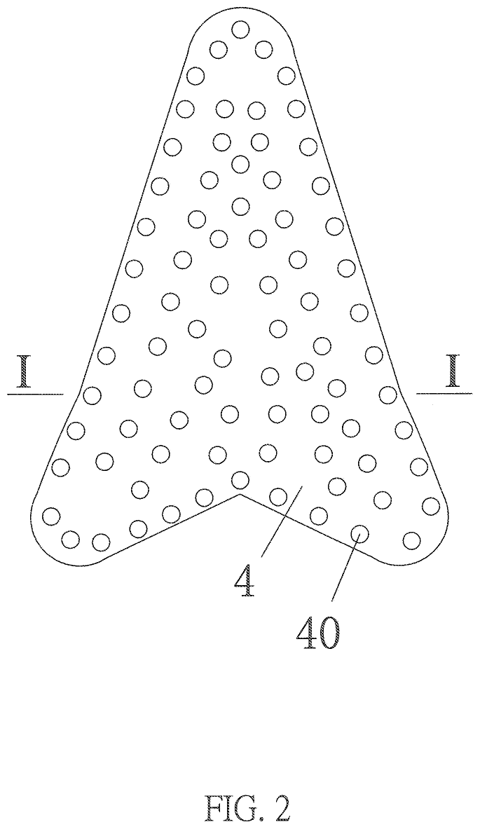

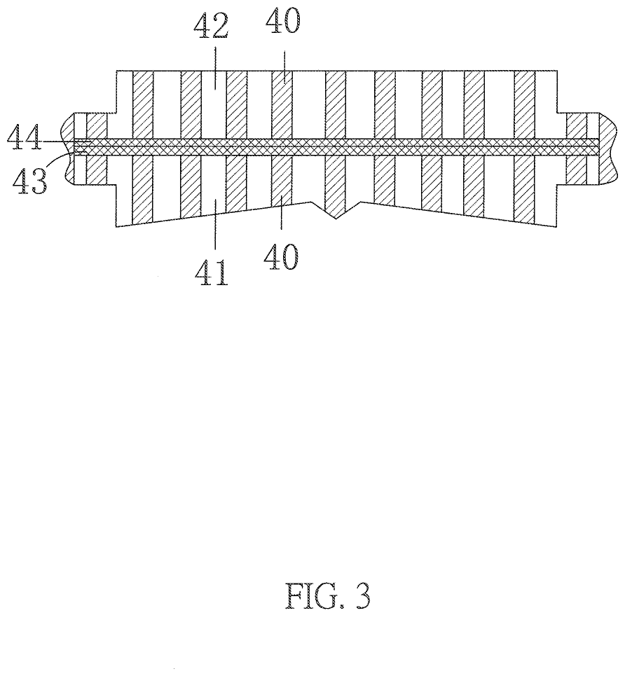

Referring to FIG. 1 through FIG. 3, the breathable sole of the invention includes a sole with upper 1, the sole includes outsole 2 and insole 3, inside the outsole 2 of the sole, a shoe breather 4 is configured, the shoe breather 4 and the outsole 2 are formed integrally as a whole, the shoe breather 4 includes breather upper portion 42, waterproof breathable film 44, steel wire mesh 43 and breather lower portion 41, the waterproof breathable film 44 and steel wire mesh 43 are fixed between the lower end of the breather upper portion 42 and the upper end of the breather lower portion 41, the waterproof breathable film 44 is located on the upper end of the steel wire mesh 43, the waterproof breathable film 44 and steel wire mesh 43 are combined together through high-temperature adhesion, the breather upper portion 42 is attached to the upper surface of the waterproof breathable film 44, the breather lower portion 41 is attached to the lower surface of the steel wire mesh 43, both the breather upper portion 42 and the breather lower portion 41 are configured with ventilating holes 40 that go through the breather from top to bottom, the ventilating holes 40 of the breather upper portion 42 are respectively aligned to the ventilating holes 40 of the breather lower portion 41 from top to bottom, with the waterproof breathable film 44 and the steel wire mesh 43 laid between them, the side of the breather lower portion 41 is integrally combined to the outsole 2, the breather upper portion 42, the breather lower portion 41 and the outsole 2 are made of the same material and are formed integrally as a whole through plastic injection, the breather upper portion 42, the breather lower portion 41, and the outsole 2 are made of rubber, the inner side of the upper end of the outsole 2 are formed with the insole 3 through plastic injection, and the insole 3 is formed on the outer end of the shoe breather 4, the shoe breather 4 runs through the outsole 2 and insole 3 from top to bottom, and the insole 3 is made of PU or EVA materials through plastic injection.

During plastic injection of the outsole 2, the shoe breather 4 is formed together. Thus, the step to fix the shoe breather 4 on the outsole 2 can be omitted and overall production efficiency is enhanced. Moreover, with the configuration of the relative ventilating holes 40, as well as the waterproof breathable film 44 and the steel wire mesh 43, the shoes become waterproof and have good air permeability. Plus, the steel wire mesh 43 can offer a good support.

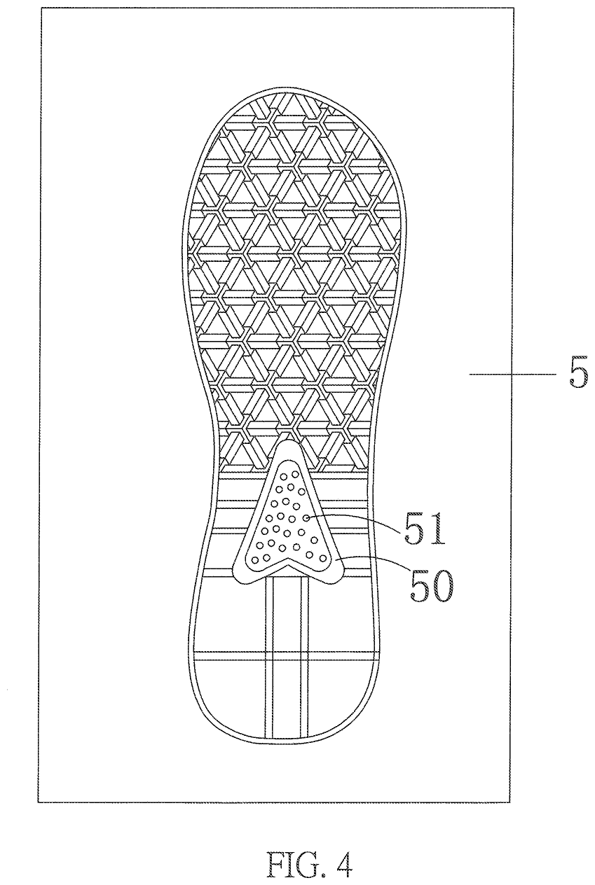

Referring to FIGS. 4˜7, the mold for producing the breathable sole includes an upper mold 5 and a lower mold 6, the upper mold 5 is provided with a downward placement trough 50, the lower mold 6 is provided with a shoe shape chamber 60 to be pressed by the upper mold 5, the upper mold 5 and lower mold 6 are both provided with injection channels, the placement trough 50 of the upper mold 5 has ventilating hole core-pulling columns 51, the shoe shape chamber 60 of the lower mold 6 also has ventilating hole core-pulling columns 51, the ventilating hole core-pulling columns 51 on the upper mold 5 are aligned to the ventilating hole core-pulling columns 51 on the lower mold 6, and when the molds are clamped together, the ventilating hole core-pulling columns 51 on the upper mold 5 will be pushed upon the ventilating hole core-pulling column 51 on the lower mold 6. Between the upper mold 5 and the lower mold 6, a waterproof breathable film 44 and a steel wire mesh 43 are provided. After the upper mold 5 and the lower mold 6 are pressed tightly, material is injected through the injection channels, and the shoe breather 4 and the outsole 2 are integrally formed inside the shoe shape chamber 60. During the injection, the waterproof breathable film 44 and the steel wire mesh 43 are combined together through high-temperature adhesion.

The present invention provides a manufacturing method for the breathable sole:

Firstly, select a set of upper mold 5 and lower mold 6, and place waterproof breathable film and steel wire mesh 43 between the upper mold 5 and lower mold 6;

Then, close the upper mold 5 and the lower mold 6, and press the upper mold 5 into the shoe shape chamber 60 of the lower mold 6;

Then, inject liquidated rubber into the space between the upper mold 5 and the lower mold 6 through the corresponding injection channels;

Then, after the mold is cooled, open the mold. The breather upper portion 42 and the breather lower portion 41 are integrally formed together with the outsole 2, and the waterproof breathable film and steel wire mesh 43 are combined together through high-temperature adhesion and are fixed between the breather upper portion 42 and the breather lower portion 41. Through the configuration of the ventilating hole core-pulling columns, after injection, ventilating holes 40 will be formed inside the breather upper portion 42 and the breather lower portion 41;

Lastly, use PU or EVA material to form the insole 3. The top of the insole 3 is at the same level as the top of the shoe breather 4. After cooling, a complete breathable sole is produced.

### Embodiment 2

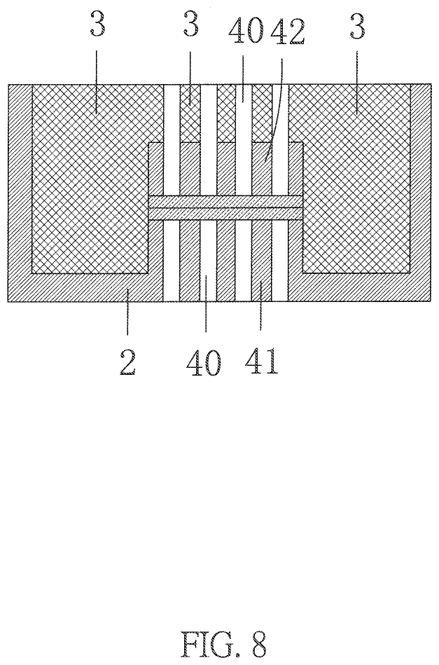

Referring to FIG. 8, this embodiment differs from the aforementioned embodiment in that, the top of the insole 3 is higher than that of the shoe breather 4 (i.e., the insole 3 encloses the shoe breather 4), the insole 3 is provided with ventilating holes 40, and the ventilating holes 40 of the insole 3 are communicated to the ventilating holes 40 of the breather upper portion 42. When the sole is pressed by the tramping force, the pressure will directly acts on the breather, the enclosure of the shoe breather 4 by the insole 3 can prevent close of the ventilating holes 40 due to deformation of the breather under pressure. As the ventilating holes 40 on the insole 3 are communicated to the ventilating holes 40 on the shoe breather 4, air permeation is still available.

### Embodiment 3

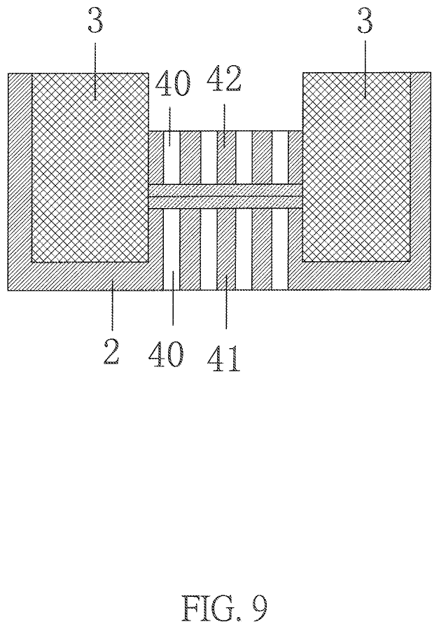

Referring to FIG. 9, this embodiment differs from the aforementioned embodiments in that, the top of the insole 3 is higher than that of the shoe breather 4, but the top of the shoe breather 4 is not enclosed by the insole 3, so as to avoid close of the ventilating holes 40 when the shoe breather 4 is squeezed to by the deformed insole 3 under the tramping force.

We claim:

1. A breathable sole, comprising:
a sole and an upper (1), the sole having an outsole (2) and an insole (3),
wherein the outsole (2) is configured with a shoe breather (4), the shoe breather (4) is integrally formed together with the outsole (2),
the shoe breather (4) includes a breather upper portion (42), a waterproof breathable film (44), a steel wire mesh (43) and a breather lower portion (41), the waterproof breathable film (44) and steel wire mesh (43) are fixed between a lower end of the breather upper portion (42) and an upper end of the breather lower portion (41), the waterproof breathable film (44) is located on an upper end of the steel wire mesh (43), and the waterproof breathable film (44) and the steel wire mesh (43) are combined together through high-temperature adhesion.

2. The breathable sole defined in claim 1, wherein the breather upper portion (42) is attached to a surface of the waterproof breathable film (44), the breather lower portion (41) is attached to a lower surface of the steel wire mesh (43), both the breather upper portion (42) and the breather lower portion (41) are provided with penetrating ventilating holes (40), and the ventilating holes (40) of the breather upper portion (42) are respectively aligned to the ventilating holes (40) of the breather lower portion (41) with the waterproof breathable film (44) and the steel wire mesh (43) placed between them, and a side of the breather lower portion (41) is fixed on the outsole (2) to form an integral body.

3. The breathable sole defined in claim 1, wherein the breather upper portion (42) and the breather lower portion (41) are made of the same material as the outsole (2) and are formed integrally as a whole through plastic injection.

4. The breathable sole defined in claim 3, wherein the breather upper portion (42), the breather lower portion (41) and the outsole (2) are made of rubber.

5. The breathable sole defined in claim 1, wherein, an inner side of an upper end of the outsole (2) is formed with an insole (3), the insole (3) is formed by injection on an outer end of the shoe breather (4), and the shoe breather (4) penetrates the outsole (2) and insole (3) from top to bottom.

6. The breathable sole defined in claim 5, wherein the insole (3) is made of PU or EVA materials through plastic injection.

7. A mold for the breathable sole defined in claim 1, including
an upper mold (5) and a lower mold (6), the upper mold (5) is provided with a downward placement trough (50), the lower mold (6) is provided with a shoe shape chamber (60) to be pressed by the upper mold (5), the upper mold (5) and lower mold (6) both have injection channels, the placement trough (50) of the upper mold (5) is provided with ventilating hole core-pulling columns (51), and the shoe shape chamber (60) of the lower mold (6) is also provided with ventilating hole core-pulling columns (51), the ventilating hole core-pulling columns (51) on the upper mold (5) are respectively paired with and alighted to the ventilating hole core-pulling columns (51) on the lower mold (6), and upon close of the molds, the ventilating hole core-pulling columns (51) on the upper mold (5) will be pushed upon the ventilating hole core-pulling columns (51) on the lower mold (6).

8. The mold for the breathable sole defined in claim 7, wherein, a waterproof breathable film (44) and a steel wire mesh (43) are configured between the upper mold (5) and the lower mold (6), when the upper mold (5) and the lower mold (6) are tightly pushed against each other, material is injected through the corresponding injection channels, the shoe breather (4) and the outsole (2) are formed integrally inside the shoe shape chamber (60), and during the injection, the waterproof breathable film (44) and the steel wire mesh (43) are adhered to each other under the high temperature.

9. A manufacturing method for the breathable sole defined in claim 1, comprising the following steps:
selecting upper mold (5) and lower mold (6), and placing a waterproof breathable film and a steel wire mesh (43) between the upper mold (5) and the lower mold (6);
closing the upper mold (5) and lower mold (6), pressing the upper mold (5) into the shoe shape chamber (60) of the lower mold (6);
pouring the rubber melt through the corresponding injection channels of the upper mold (5) and the lower mold (6) respectively;
opening the mold after it cools down, the breather upper portion (42), the breather lower portion (41) and the outsole (2) are formed integrally, the waterproof breathable film and the steel wire mesh (43) are fixed between the breather upper portion (42) and the breather lower portion (41) through adhesion under the high temperature, and through configuration of the ventilating hole core-pulling columns, after injection is completed, ventilating holes (40) will be formed between the breather upper portion (42) and the breather lower portion (41);
pouring the insole (3) with PU or EVA material, the top of the insole (3) being at the same level as the top of the shoe breather (4), and a complete breathable sole structure is formed after cooling.
